(19) United States
(12) Patent Application Publication
(10) Pub. No.: US 2026/0122182 A1
(43) Pub. Date: Apr. 30, 2026

(54) APPARATUS AND METHOD FOR ADJUSTING ESTIMTED WAIT TIME IN A CONTACT CENTER

(71) Applicant: SWAMPFOX TECHNOLOGIES, INC., Columbia, SC (US)

(72) Inventors: Sergey A. Razin, Columbia, SC (US); Paul Clements, Lexington, SC (US)

(73) Assignee: SWAMPFOX TECHNOLOGIES, INC., Columbia, SC (US)

(21) Appl. No.: 18/930,600

(22) Filed: Oct. 29, 2024

(51) Int. Cl. H04M 3/523

(52) U.S. Cl. CPC H04M 3/5238

(57) ABSTRACT

A predictor device is configured to identify user wait time in a call queue and comprises a controller having a processor and a memory. The controller is configured to: identify a number of user calls in the call queue; predict a change in the number of user calls in the call queue; generate a predicted wait time based upon the predicted change in the number of user calls in the call queue; and provide the predicted wait time as the user wait time to a contact center server device.

### BACKGROUND

In conventional customer contact centers, incoming communications, such as voice calls or texts for example, can be received and answered by an agent pool. During operation, the contact center can automatically distribute and connect incoming communications to available agents or to agents best suited to handle the communications. In the case where no suitable agents are available, the customer contact center can become overloaded and can place the communications in a variety of queues based upon some pre-established criteria, such as based on the order of arrival and/or priority.

One of the priorities of a contact center is to be predictive of its load, which allows for better planning and scheduling of the available resources. Another priority of the contact center is to accurately set expectations with the customer and deliver on those established expectations once set. Setting and delivering on the established expectations closely relates to customer experience, as well as service levels.

Both of these priorities can be achieved by applying machine learning algorithms to a variety of contact center operational data such as agent staffing, call arrival rate, call handling rate, and seasonality, for example. Such an approach can provide the ability for the contact center to provide a metric known as estimated wait time (EWT). The estimated wait time can identify an amount of time a customer is estimated to wait before being serviced by an agent. Based upon application of a variety of machine learning algorithms and their corresponding hyperparameters to contact center operational data, the contact center EWT can be derived which, in turn, can be used to identify the appropriate number of agents to be staffed by the contact center, as well as to set the expectation with the customer by reporting or acting within the estimated wait time. The EWT can also be utilized to identify where callers should be routed in the contact center (e.g., by placing the callers in a queue with the lowest wait time).

### SUMMARY

The success of any contact center is based upon the accuracy of the wait time estimation. For example, based upon the EWT, the customer contact center can make decisions to efficiently route calls or to determine whether or not an offer for a callback should be placed. The accuracy of the EWT can depend upon the accuracy of the conventional contact center's statistics, since traditional statistical rules and heuristics are utilized to produce accurate EWTs. However, even with accurate contact center statistics, other factors, such as caller behavior, can affect the overall accuracy of the EWT's. For example, while waiting, callers may leave a contact center's call queue, particularly for relatively long wait times. Further, callers who have been scheduled to call back to the contact center at a later time may decide not to do so. In either case, caller behavior can lead to inaccuracies in the contact center's EWT. This can result in the contact center being penalized for not meeting customer expectation.

Embodiments of the present innovation relate to an apparatus and method for adjusting estimated wait time in a contact center. In one arrangement, a contact center can utilize a predictor device that is configured to identify a change in the number of user calls in a call queue and to adjust the estimated wait time (EWT) based upon that change, thereby increasing the accuracy of the EWT. In one arrangement, the contact center can utilize the adjusted EWT to route the users in the call queue to domestic resources associated with the contact center. For example, by load balancing the users in the call queue to domestic resources, the call center can mitigate the need to utilize offshore resources, such as additional call centers, to address the users in the call queue. This, in turn, results in reduced outsourcing cots and a reduction in the actual wait time experienced by the users. In one arrangement, the contact center can utilize the enhanced EWT to provide one or more users within the call queue with the opportunity to receive a call back from the contact center, thereby reducing the actual wait time experienced by the users remaining in the queue. With such utilization of a relatively more accurate EWT, the contact center can meet call center regulations and can mitigate penalization for not meeting customer expectations.

In one arrangement, embodiment of the present innovation relates to, a method for estimating user wait time in a call queue, comprising: identifying, by a predictor device, a number of user calls in the call queue; predicting, by the predictor device, a change in the number of user calls in the call queue; generating, by the predictor device, a predicted wait time based upon the predicted change in the number of user calls in the call queue; and providing, by the predictor device, the predicted wait time as the user wait time to a contact center server device.

In one arrangement, embodiment of the present innovation relates to a predictor device configured to estimate user wait time in a call queue, the predictor device comprising a controller having a processor and a memory where the controller is configured to: identify a number of user calls in the call queue; predict a change in the number of user calls in the call queue; generate a predicted wait time based upon the predicted change in the number of user calls in the call queue; and provide the predicted wait time as the user wait time to a contact center server device.

In one arrangement, embodiment of the present innovation relates to a contact center, comprising: a server device comprising a controller having a processor and a memory, the controller comprising a call queue configured to contain a number of user calls; and a predictor device disposed in electrical communication with the server device and configured to estimate user wait time in the call queue, the predictor device comprising a controller having a processor and a memory. The controller of the predictor device is configured to: identify a number of user calls in the call queue, predict a change in the number of user calls in the call queue, generate a predicted wait time based upon the predicted change in the number of user calls in the call queue, and provide the predicted wait time as the user wait time to the server device.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a contact center having a predictor device configured to adjust estimated wait time, according to one arrangement

FIG. 2 illustrates a flow chart of a method for estimating user wait time in a call queue, such as provided by the predictor device of FIG. 1, according to one arrangement.

FIG. 3 illustrates a schematic representation of the predictor device of FIG. 1, according to one arrangement.

FIG. 4 illustrates a schematic representation of the predictor device of FIG. 1 configured to estimate user wait time based on a predicted abandonment of callers within a call queue, according to one arrangement.

FIG. 5 illustrates a schematic representation of the predictor device of FIG. 1 configured to estimate user wait time based on a predicted call back failure, according to one arrangement.

FIG. 6 illustrates a schematic representation of the predictor device of FIG. 1 configured to estimate user wait time based on a rate of change of callers within a call queue, according to one arrangement.

### DETAILED DESCRIPTION

Embodiments of the present innovation relate to an apparatus and method for adjusting estimated wait time in a contact center. In one arrangement, a contact center can utilize a predictor device that is configured to identify a change in the number of user calls in a call queue and to adjust the estimated wait time (EWT) based upon that change, thereby increasing the accuracy of the EWT. In one arrangement, the contact center can utilize the adjusted EWT to route the users in the call queue to domestic resources associated with the contact center. For example, by load balancing the users in the call queue to domestic resources, the call center can mitigate the need to utilize offshore resources, such as additional call centers, to address the users in the call queue. This, in turn, results in reduced outsourcing cots and a reduction in the actual wait time experienced by the users. In one arrangement, the contact center can utilize the enhanced EWT to provide one or more users within the call queue with the opportunity to receive a call back from the contact center, thereby reducing the actual wait time experienced by the users remaining in the queue. With such utilization of a relatively more accurate EWT, the contact center can meet call center regulations and can mitigate penalization for not meeting customer expectations.

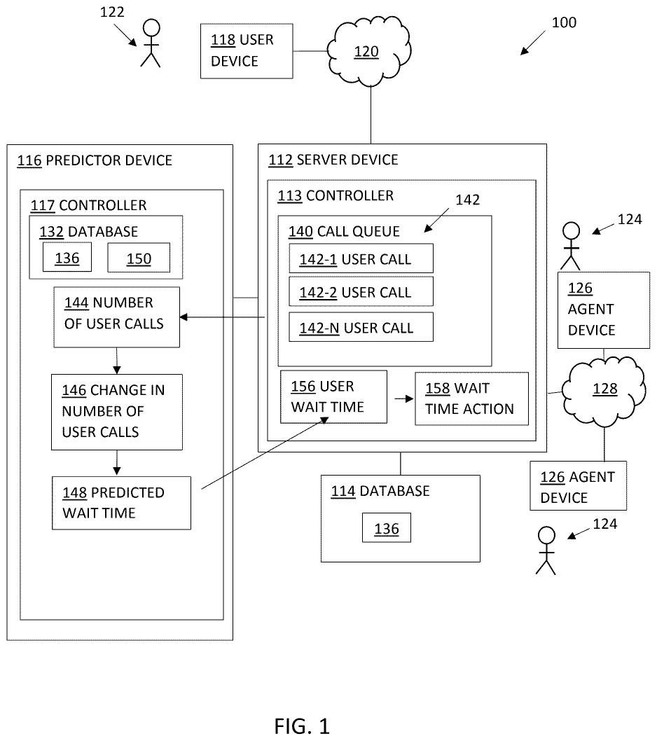

FIG. 1 illustrates a schematic representation of a contact center 100, according to one arrangement. The contact center 100 can include one or more contact center server devices 112 disposed in electrical communication with one or more data stores or databases 114 and a predictor device 116 disposed in electrical communication with the server devices 112.

The server device 112 can be a computerized device having a controller 113, such as a processor and memory. According to one arrangement, server device 112 is disposed in electrical communication with a user device 118, such as a telephone, smartphone, or tablet device, via a network 120, such as a local area network (LAN), a wide area network (WAN), or a public switched telephone network (PSTN). During operation, the server device 112 is configured to direct a user 122 of the user device 118, or customer, to an appropriate working agent 124 associated with the contact center 100. Each working agent 124 can operate a corresponding computer work station, or agent device, 126, such as a personal computer, telephone, tablet device or other type of voice communications equipment, all interconnected by a network 128, such as a LAN or WAN 128. Also during operation, the server device 112 can store information regarding the user communication to the database 114. For example, the server device 112 can store contact or customer related information for each communication session associated with the user device 118 in the database 114, as well as other information that can enhance the value and efficiency of the contact information, such as historical data 136.

The predictor device 116 can be a computerized device having a controller 117, such as a processor and memory. The predictor device 116 is configured to generate an estimated wait time (EWT) for the user or caller 122 within the contact center 100. For example, the predictor device 116 can utilize contact center statistics, such as information regarding user communications stored by the database 114, along with conventional statistical rules and heuristics, to generate EWT. However, the accuracy of the EWT can depend upon the accuracy of the conventional contact center's statistics. In order to increase the relative accuracy of the EWT, the predictor device 116 is configured to generate an estimated user wait time 156 of the user or caller 122 based upon predicted changes to a call queue 140, such as associated with the server device 112, as will be described below.

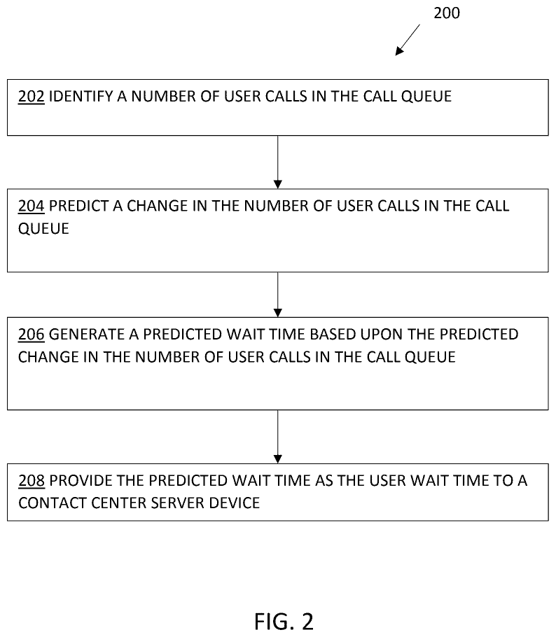

FIG. 2 illustrates a flow chart 200 of an example process executed by the predictor device 116 when estimating user wait time in the call queue 140, according to one arrangement.

In element 202, the predictor device 116 is configured to identify a number of user calls 144 in the call queue 140. With reference to FIG. 1, the controller 113 of the server device 112 includes a call queue 140 having user communications or calls 142 (e.g., calls texts, etc.) received by the call center 100. In one arrangement, the server device 112 can add the user calls 142 to the call queue 140 in the order the calls 142 were received. For example, the server device 112 can add a first caller 122 as user call 142-1, a second caller 122 as user call 142-2 and an n^{th} caller 122 as user call 142-N within the queue. As such, the predictor device 116 is configured to identify the number of user calls 142 present in the call queue 140 at a particular time. For example, at a given interval (e.g., once every ten minutes, thirty minutes, etc.) the predictor device 116 can count or identify the number of user calls 142 within the call queue 140 and can retrieve this information as the number of user calls 144 within the queue 140.

In another arrangement, when identifying the number of user calls 144 I the call queue 140, the predictor device 116 is configured to estimate the number of user calls 144 within the queue 140, such as based upon historical data 136 associated with the contact center 100. For example, the historical data 136 can identify the average number of user calls 142 within the call queue 140 based upon a time metric (e.g., time of day, month of year, etc.), an environmental metric (e.g., weather event, etc.), or some other metric that can affect the number of user calls 142 received by the contact center 100. The predictor device 116 can utilize the historical data 136 to generate a relatively accurate estimate the number of user calls 144 within the call queue 140 at a given time.

Returning to FIG. 2, in element 204, the predictor device 116 is configured to predict a change in the number of user calls 146 in the call queue 140. In one arrangement, with reference to FIG. 1, the predictor device 116 is configured to utilize the number of user calls 144 identified in the call queue 140 to predict the change in the number of user calls 146. Such prediction can be done in a variety of ways. For example, as will be described in detail below, the predictor device 116 can predict the change in the number of user calls 146 based upon a prediction of a number of users 112 who abandon or leave the call queue 140 or, for users 122 who have been given a call back option, based upon a prediction of a number of users 122 who fail to accept the call back from the contact center 100.

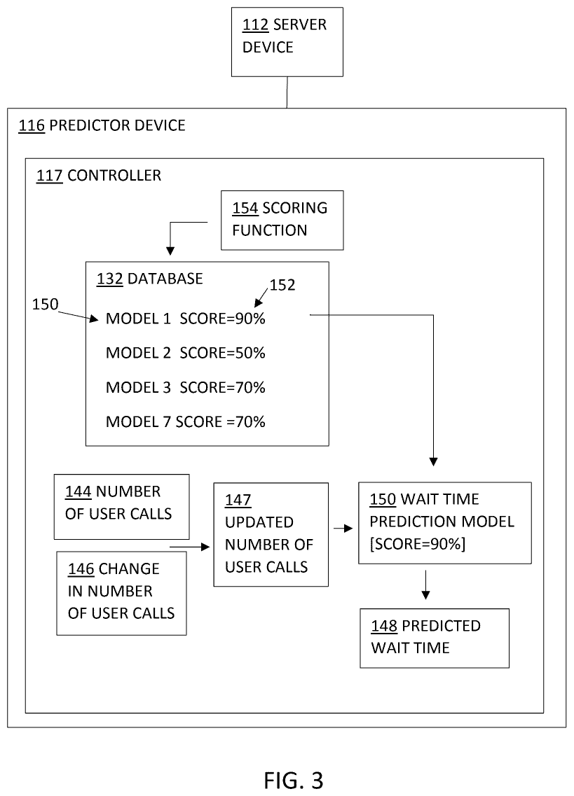

Returning to FIG. 2, in element 206, the predictor device 116 is configured to generate a predicted wait time 148 based upon the predicted change in the number of user calls 146 in the call queue 140. While the generation of the predicted wait time 148 can be performed in a variety of ways, in one arrangement, and with reference to FIG. 3, the predictor device 116 can apply an updated number of user calls 147 in the call queue 140 to a wait time prediction model 150 to generate the predicted wait time 148.

In one arrangement, to generate the updated number of user calls 147, the predictor device 116 can detect a difference between the predicted change in the number of user calls 146 in the call queue 140 and the number of user calls 144 identified in the call queue 140. For example, assume the case where the predictor device 116 identifies ten user calls 144 in the call queue 140 and predicts a decrease of two user calls as the change in the number of calls 146. By calculating the difference between the ten user calls 144 and the two user calls 146, the predictor device 116 can identify the updated number of user calls 147 as a total of eight user calls. Following the identification of the updated number of user calls 147, the predictor device 116 is configured to apply the updated number of user calls 147 to the wait time prediction model 150.

The wait time prediction model 150 can be obtained by the predictor device 116 in a variety of ways. In one arrangement, with continued reference to FIG. 3, the predictor device 116 is configured to select a wait time prediction model 150 from a set of wait time prediction models within a database 132 based upon a score 152 quantifying a performance of each wait time prediction 150. For example, the predictor device 116 is configured to quantify the accuracy or quality for each model 150 of the set of models, such as by applying a scoring function 154 to each of the data models 150, in order to generate corresponding scores 152 identifying the performance of each. As such, the predictor device 116 can select the model 150 having an indication of the relatively highest quality, as evidenced by a score 152, as the best wait time prediction model and can deploy that selected best wait time prediction model 150 to generate the predicted wait time 148. For example, the predictor device 116 can feed the updated number of user calls 147 (e.g., eight calls) to the wait time prediction model 147 to generate the predicted wait time 148 (e.g., nine minutes).

Further, the predictor device 116 can train each wait time prediction model 150 in a variety of ways. For example, the predictor device 116 can train each wait time prediction model 150 on the number of calls received by the call center 100 and the rate of abandonment of user calls within the call queue 140.

Returning to FIG. 2, in element 208, the predictor device 116 is configured to provide the predicted wait time 148 as the user wait time 156 to a contact center server device 112. In one arrangement, the server device 112 can provide the predicted wait time 148 to the user 122 to notify the user 122 as to when they can expect service. In another arrangement, with reference to FIG. 1, the server device 112 can utilize the user wait time 156 to generate a corresponding wait time action 158 with respect to the user calls 142 within the call queue 140. For example, based on the user wait time 156, the server device 112 can generate, as the wait time action 158, a routing of user calls 142 in the call queue 140 to domestic resources (e.g., additional agents 124) associated with the contact center 100 to reduce the user's wait time (e.g., a three-minute wait time with the wait time action 158 versus a nine-minute wait time without the wait time action 158). In another example, based on the user wait time 156, the server device 112 can activate, as the wait time action 158, a use call back application (not shown) to offer particular users 122 the option of receiving a call back from the contact center 100, thereby reducing the number of user calls 142 within the call queue 140 and reducing the wait time for the remaining users 122.

With use of the predictor device 116, the contact center 100 can identify a change in the number of user calls 142 in a call queue 140 and can generate a predicted wait time 148 which a that change, thereby increasing the accuracy of the EWT. With such utilization of a relatively more accurate EWT, the contact center 100 can meet call center regulations and can mitigate penalization for not meeting customer expectations.

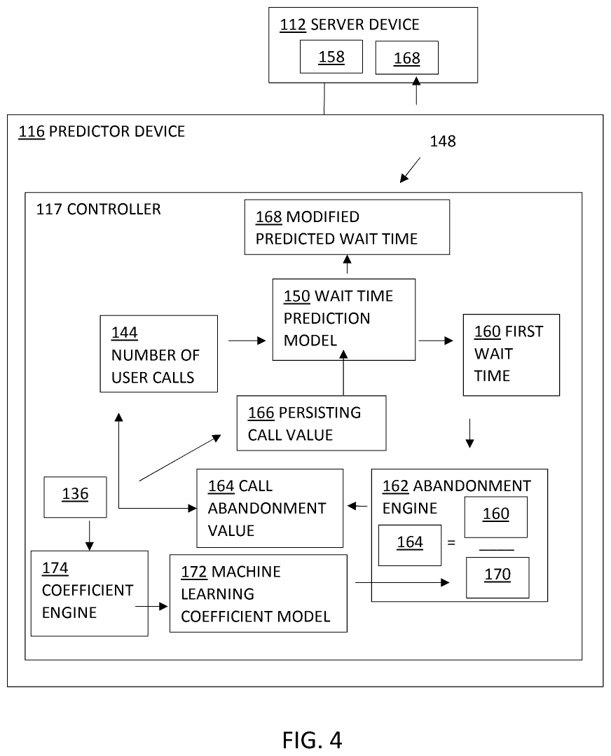

As provided above, the predictor device 116 is configured to predict a change in the number of user calls 146 in a call queue 140 in a variety of ways, such as based upon a prediction of a number of users 122 who abandon or leave the call queue 140 while waiting to be serviced. In one arrangement, and with reference to FIG. 4, the predictor device 116 can utilize a wait time prediction model 150 to predict user abandonment in the call queue 140 and to adjust the user wait time estimate 156 accordingly.

During operation, and with reference to FIG. 4, following identification of the number of user calls 144 in the call queue 140, the predictor device 116 is configured to first apply the identified number of user calls 144 to the wait time prediction model 150 to generate a first wait time 160. For example, assume the case where there are twenty identified user calls 144 in the call queue 140 at a given time and the predictor device 116 feeds the twenty identified user calls 144 into the wait time prediction model 150. The wait time prediction model 150 can, as a result, generate a first wait time 160, such as an estimated user wait time of fifteen minutes.

Next, the predictor device 116 is configured to apply the first wait time 160 to an abandonment engine 162 to identify a call abandonment value 164 which represents the number of user calls 142 in the call queue 140 that are expected to drop. In one arrangement, the abandonment engine 162 is configured to apply an abandonment coefficient 170 to the first wait time 160 to generate the call abandonment value 164. For example, the abandonment engine 162 can divide the first wait time 160 by the abandonment coefficient 170 to generate the call abandonment value 164. In the present case, assume the abandonment coefficient 170 has a value of three. As such, dividing the first wait time 160 value of fifteen minutes by the abandonment coefficient 170 value of three results in a call abandonment value 164 having a value of five predicted user calls 142 to leave the call queue 140.

In one arrangement, the predictor device 116 is configured to derive the abandonment coefficient 170 via a machine learning coefficient model 172. For example, the predictor device 116 can train a coefficient engine 174 with historic data 136 to generate the machine learning coefficient model 172. Further, the predictor device 116 can utilize the call abandonment values 164 generated by the abandonment engine 162 to continue to train the coefficient engine 174 over time in order to produce updated or refined machine learning coefficient models 172.

Next, the predictor device 116 is configured to identify a difference between the call abandonment value 164 and the identified number of user calls 144 in the call queue 140 as a persisting call value 166. For example, the predictor device 116 can subtract the call abandonment value 164 of five predicted user calls 142 to leave the call queue 140 from the twenty identified user calls 144 in the call queue 140 to generate a persisting call value 166 of fifteen user calls 142 that are expected to remain within the call queue 140.

Following generation of the persisting call value 166, the predictor device 116 is configured to apply the persisting call value 166 to the wait time prediction model 150 to generate a modified predicted wait time 168 as the predicted wait time 148. For example, the predictor device 116 can provide the persisting call value 166 of fifteen calls that are expected to persist within the call queue 140 to the wait time prediction model 150. As a result, the wait time prediction model 150 can generate the modified predicted wait time 168, for example, a time of seven minutes. The predictor device 116 can forward the modified predicted wait time 168 to the server device 112 which, in response, can utilize the modified predicted wait time 168 to determine how to address the users 122 and the associated wait time within the contact center call queue 140. For example, the sever device 112 can forward the modified predicted wait time 168 to a user 122. In another example, the sever device 112 can perform a wait time action 158 (e.g., load balance the user calls 142 within the call center 100) based upon the modified predicted wait time 168 of seven minutes for the call queue 140.

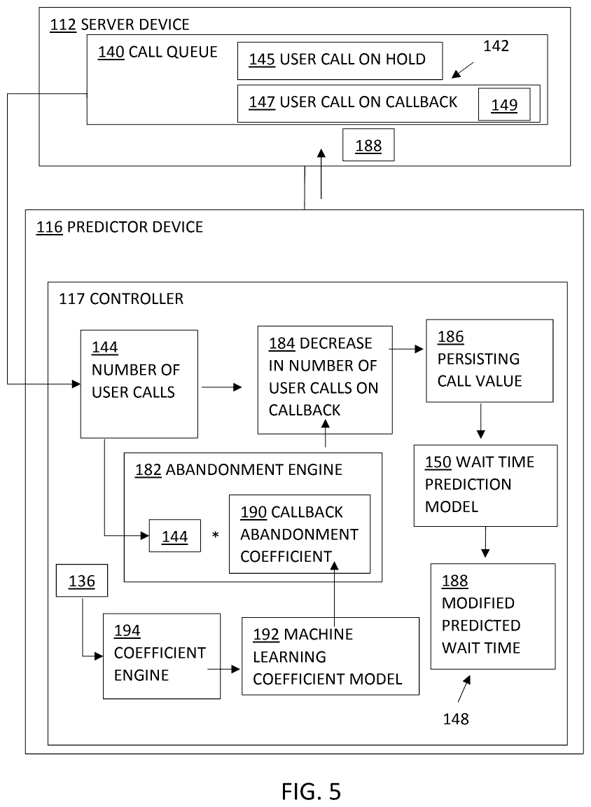

As provided above, the predictor device 116 is configured to predict a change in the number of user calls 146 in a call queue 140 in a variety of ways. In one arrangement, the contact center 100 can be configured to provide services to both user calls on hold 145 and user calls on callback 147. With reference to FIG. 5, in the case where the predictor device 116 identifies user calls 142 within the call queue 140 as being assigned a call back call from the contact center 100, the predictor device 116 is configured to predict a number of those user calls 142 that will fail to accept the call back and to adjust the user wait time estimate 156 accordingly.

As provided above, the server device 112 includes a call queue 140 configured to contain user calls 142 received by the call center 100. In one arrangement, these user calls 142 can include user calls on hold 145, where the users 122 are waiting on their user device 118 to be serviced by the contact center 100, and user calls on callback 147, where the users 122 are not on hold but rather are waiting for a call back from the contact center 100 at a particular time. With such an arrangement, when identifying the number of user calls 144 in the call queue 140, the predictor device 116 is configured to identify one or more of the user calls 142 in the call queue 140 as being user calls on callback 147. For example, assume the predictor device 116 identifies a total of seventeen user calls 144 in the call queue 140. The predictor device 116 can review the seventeen user calls 144 to identify whether or not one or more of the user calls 142 is configured as a user call on callback 147, such as based upon the presence of a callback indicator 149. For example, the callback indicator 149 can be configured as identifying the user call on callback 147 as being a placeholder in the call queue 140 for those users 122 who are awaiting a call back from the call center 100.

Next, the predictor device 116 is configured to predict a decrease in the number of user calls on callback 184. In one arrangement, the predictor device 116 is configured to apply a callback abandonment coefficient 190 to the identified number of user calls 144 to generate the decrease in the number of user calls on callback 184. For example, an abandonment engine 182 can multiply the number user calls 144 in the call queue 140 by the callback abandonment coefficient 190. In the present case, assume the callback abandonment coefficient 190 has a value of 0.1 and the predictor device 116 has identified seventeen user calls 144 in the call queue 140. As such, multiplying the callback abandonment coefficient 190 value of 0.1 by the identified seventeen user calls 144 results in a predicted decrease of about two of user calls on callback 184 within the call queue 140.

In one arrangement, the predictor device 116 is configured to derive the callback abandonment coefficient 190 via a machine learning callback coefficient model 192. For example, the predictor device 116 can train a callback coefficient engine 194 with historic data 136 to generate the machine learning callback coefficient model 192. Further, the predictor device 116 can utilize the predicted decrease in the number of user calls on callback 184 values to continue to train the callback coefficient engine 194 over time in order to generate updated or refined machine learning callback coefficient models 192.

Next, the predictor device 116 is configured to identify a difference between the identified number of user calls 144 in the call queue 140 and the predicted decrease in the number of user calls on callback 184 as a persisting call value 186. For example, in the present example, the predictor device 116 can subtract the predicted decrease of two user calls on callback 184 from the seventeen identified user calls 144 in the call queue 140 to generate a persisting call value 186 of fifteen user calls in the call queue 140.

Next, the predictor device 116 is configured to apply the persisting call value 186 to the wait time prediction model 150 to generate a modified predicted wait time 188 as the predicted wait time 148. For example, the predictor device 116 can provide the persisting call value 186 of fifteen calls that are expected to persist within the call queue 140 to the wait time prediction model 150. As a result, the wait time prediction model 150 can generate the modified predicted wait time 188, such as a time of seven minutes, to account for users who are predicted not to answer a callback from the call center 100. The predictor device 116 can forward the modified predicted wait time 188 to the server device 112 which, in response, can utilize the modified predicted wait time 188 to determine how to address the users 122 and the associated wait times within the contact center call queue 140. For example, the sever device 112 can perform a wait time action 158 (e.g., load balance the user calls 142 within the call center 100, notify the user 122, etc.) based upon the estimated wait time of seven minutes for the call queue 140.

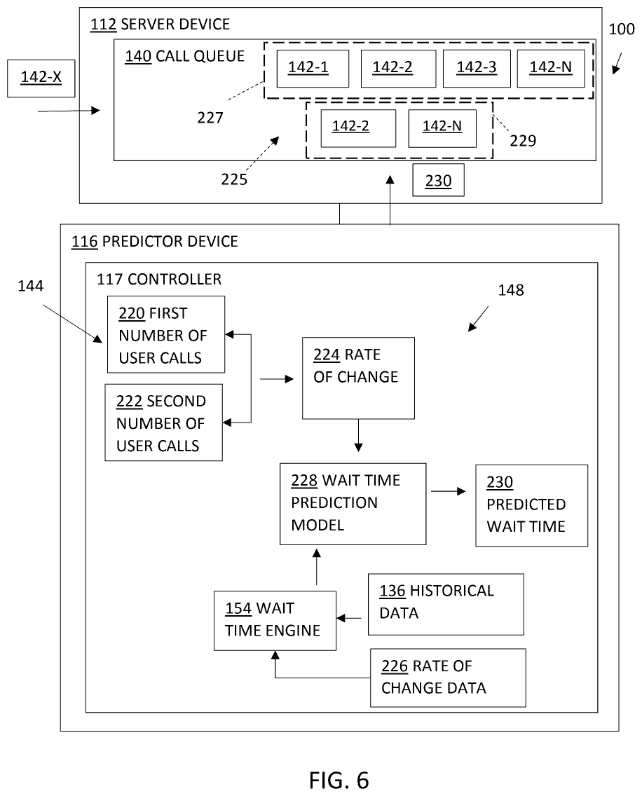

As provided above, the predictor device 116 is configured to generate a predicted wait time 148 based upon a predicted change in the number of user calls 142 in the call queue 140. In one arrangement, and with reference to FIG. 6, the predictor device 116 is configured to predict estimated wait time based upon a rate of change of user calls 142 in the call queue 140.

During operation, and as provided above, the server device 112 is configured to hold a number of user calls 142 within the call queue 140. For example, the server device 112 can add user calls 142 to the call queue 140 in the order the calls 142, such as by adding a first caller 122 as user call 142-1, a second caller 122 as user call 142-2 and an n^{th} caller 122 as user call 142-N to the call queue 140. However, over a given period of time or time duration 225, the number of user calls 142 in the call queue 140 can change. For example, the server device 112 can continuously add new user calls 142 to the call queue 140 and remove existing user calls 142 from the call queue 140, such as those calls that have been forward to agents 124 or otherwise serviced by the call center 100. In one arrangement, the predictor device 116 can utilize the rate of change of user calls 142 in the call queue 140 to enhance estimation of user wait time.

Initially, in order to account for the rate of change of user calls 14 within the call queue 140, the predictor device 116 is configured to train a wait time engine 154 with historical data 136 and rate of change data 226. For example, as provided above, the historical data 136 can identify the average number of user calls 142 within the call queue 140 based upon a time metric (e.g., time of day, month of year, etc.), an environmental metric (e.g., weather event, etc.), or some other metric that can affect the number of user calls 142 received by the contact center 100. Further, the rate of change data 226 can identify the rate of change in the number of user calls 142 in the call queue 140, such as corresponding to the time metric or environmental metric. By training the wait time engine 154 with both the historical data 136 and the rate of change data 226, the predictor device 116 is configured to generate an enhanced wait time prediction model 228 which relates to the rate of change of user caller 142 in the call queue 140.

During operation, following the receipt of a user call 142-X by the call center 100, the predictor device 116 is configured to generate a predicted wait time 148 based upon the rate of change of user caller 142 in the call queue 140 for a given time duration 225. In one arrangement, the predictor device 116 is configured to identify the number of user calls 144 in the call queue 140 for a time duration 225 preceding the time of receipt of the user call 142-X. For example, assume the time duration 225 is preconfigured as a ten-minute window. The predictor device 116 can divide the ten-minute window 225 into two time periods of equal duration—a first time period 227 of five-minutes duration (e.g., a duration of five minutes following receipt of the user call 142-X) and a second time period 229 of five minutes duration (e.g., a duration of five minutes following the first time period 227). The predictor device 116 can then identify a first number of user calls 220 in the call queue 140 for the first time period 227 and a second number of user calls 222 in the call queue 140 for the second time period 229.

For example, assume the case where, during the first time period 227, the call queue 140 includes user calls 142-1, 142-2, 142-3, and 142-N and during the second time period 229, the call queue 140 includes user calls 142-2 and 142-N. The predictor device 116 can identify or count the four user calls 220 in the call queue 140 for the first time period 227 and can identify or count the two user calls 222 in the call queue 140 for the second time period 229.

Next, the predictor device 116 is configured to identify a rate of change 224 in the number of user calls 142 in the call queue 140 between the second number of user calls 222 in the call queue 140 for the second time period 229 of the time duration 225 and the first number of user calls 220 in the call queue 140 for the first time period 227 of the time duration 225. For example, the predictor device 116 can divide the first number of user calls 220 (e.g., four user calls) by the second number of user calls 222 (e.g., two user calls) to identify the rate of change of user calls within the call queue 140 for the time duration 225 (e.g., a rate of change of two user calls for the time duration 225).

Next, the predictor device 116 is configured to apply the rate of change 224 in the number of user calls 142 in the call queue 140 to a wait time prediction model 228 to generate the predicted wait time 230 associated with user call 142-X.

For example, assume the case where the wait time prediction model 228 generates a predicted wait time 230, such as a time of four minutes. The predictor device 116 can forward the predicted wait time 230 to the server device 112 which, in response, can utilize the modified predicted wait time 230 to determine how to address user call 142-X. For example, the sever device 112 can perform a wait time action 158 (e.g., load balance the user call 142-X within the call center 100, notify the user 122, etc.) based upon the predicted wait time 230.

As provided above, in order to generate an estimated wait time for the call queue 140 of a call center 100, the predictor device 116 is configured to predict a change in the number of user calls 146 in a call queue 140. For example, as described above, the predictor device 116 can generate an estimated wait time for the call queue 140 based upon a prediction of a number of user calls 122 who abandon or leave the call queue 140 while waiting to be serviced or based upon a prediction of a number of user calls 122 who have been assigned a call back call from the contact center 100 and who fail to accept the call back. Such description is by way of example only. In one arrangement, the predictor device 116 is configured to generate an estimated wait time for the call queue 140 based upon both a prediction of the number of user calls 122 who abandon or leave the call queue 140 while waiting to be serviced and a prediction of a number of user calls 122 who have been assigned a call back call from the contact center 100 and who fail to accept the call back.

While various embodiments of the innovation have been particularly shown and described, it will be understood by those skilled in the art that various changes in form and details may be made therein without departing from the spirit and scope of the innovation as defined by the appended claims.

What is claimed is:

1. A method for estimating user wait time in a call queue, comprising:
identifying, by a predictor device, a number of user calls in the call queue;
predicting, by the predictor device, a change in the number of user calls in the call queue;
generating, by the predictor device, a predicted wait time based upon the predicted change in the number of user calls in the call queue; and
providing, by the predictor device, the predicted wait time as the user wait time to a contact center server device.

2. The method of claim 1, wherein generating the predicted wait time based upon the predicted change in the number of user calls in the call queue comprises applying, by the predictor device, an updated number of user calls in the call queue to a wait time prediction model to generate the predicted wait time.

3. The method of claim 2, further comprising selecting, by the predictor device, the wait time prediction model from a set of wait time prediction models based upon a score quantifying a performance of each wait time prediction model.

4. The method of claim 2, wherein:
predicting the change in the number of user calls in the call queue comprises:
applying, by the predictor device, the identified number of user calls in the call queue to the wait time prediction model to generate a first wait time,
applying, by the predictor device, the first wait time to an abandonment engine to identify a call abandonment value, and
identifying, by the predictor device, a difference between the call abandonment value and the identified number of user calls in the call queue as a persisting call value; and
generating the predicted wait time based upon the predicted change in the number of user calls in the call queue comprises applying, by the predictor device, the persisting call value to the wait time prediction model to generate a modified predicted wait time as the predicted wait time.

5. The method of claim 4, wherein applying the first wait time to the abandonment engine to identify the call abandonment value comprises applying, by the predictor device, an abandonment coefficient to the first wait time according to the relationship: first wait time / abandonment coefficient.

6. The method of claim 2, wherein:
identifying the number of user calls in the call queue further comprises identifying, by the predictor device, of the number of user calls in the call queue, a user call on callback; and
predicting the change in the number of user calls in the call queue comprises:
predicting, by the predictor device, a decrease in the number of user calls on callback,
identifying, by the predictor device, a difference between the identified number of user calls in the call queue and the predicted decrease in the number of user calls on callback as a persisting call value; and
generating the predicted wait time based upon the predicted change in the number of user calls in the call queue comprises applying, by the predictor device, the persisting call value to the wait time prediction model to generate a modified predicted wait time as the predicted wait time.

7. The method of claim 6, wherein predicting the decrease in the number of user calls on callback comprises applying, by the predictor device, a callback abandonment coefficient to the identified number of user calls according to the relationship: number of user calls in the call queue multiplied by the callback abandonment coefficient.

8. The method of claim 1, wherein:
identifying the number of user calls in the call queue comprises identifying, by the predictor device, a first number of user calls in the call queue for a first time period of a time duration and a second number of user calls in the call queue for a second time period of the time duration;
predicting the change in the number of user calls in the call queue for the time duration comprises identifying a rate of change in the number of user calls in the call queue between the second number of user calls in the call queue for the second time period of the time duration and the first number of user calls in the call queue for the first time period of the time duration;
generating the predicted wait time based upon the predicted change in the number of user calls in the call queue comprises applying, by the predictor device, the rate of change in the number of user calls in the call queue to a wait time prediction model to generate the predicted wait time.

9. A predictor device configured to estimate user wait time in a call queue, the predictor device comprising:
a controller having a processor and a memory, the controller configured to:
identify a number of user calls in the call queue;
predict a change in the number of user calls in the call queue;
generate a predicted wait time based upon the predicted change in the number of user calls in the call queue; and
provide the predicted wait time as the user wait time to a contact center server device.

10. The predictor device of claim 9, wherein when generating the predicted wait time based upon the predicted change in the number of user calls in the call queue the controller is configured to apply an updated number of user calls in the call queue to a wait time prediction model to generate the predicted wait time.

11. The predictor device of claim 10, wherein the controller is further configured to select the wait time prediction model from a set of wait time prediction models based upon a score quantifying a performance of each wait time prediction model.

12. The predictor device of claim 9, wherein:
when predicting the change in the number of user calls in the call queue, the controller is configured to:
apply the identified number of user calls in the call queue to the wait time prediction model to generate a first wait time,
apply the first wait time to an abandonment engine to identify a call abandonment value, and
identify a difference between the call abandonment value and the identified number of user calls in the call queue as a persisting call value; and
when generating the predicted wait time based upon the predicted change in the number of user calls in the call queue, the controller is configured to apply the persisting call value to the wait time prediction model to generate a modified predicted wait time as the predicted wait time.

13. The predictor device of claim 12, wherein when applying the first wait time to the abandonment engine to identify the call abandonment value the controller is configured to apply an abandonment coefficient to the first wait time according to the relationship: first wait time / abandonment coefficient.

14. The predictor device of claim 9, wherein:
when identifying the number of user calls in the call queue the controller is configured to identify, of the number of user calls in the call queue, a user call on callback; and
when predicting the change in the number of user calls in the call queue the controller is configured to:
predict a decrease in the number of user calls on callback, and
identify a difference between the identified number of user calls in the call queue and the predicted decrease in the number of user calls on callback as a persisting call value; and
when generating the predicted wait time based upon the predicted change in the number of user calls in the call queue the controller is configured to apply the persisting call value to the wait time prediction model to generate a modified predicted wait time as the predicted wait time.

15. The predictor device of claim 14, wherein when predicting the decrease in the number of user calls on callback the controller is configured to apply a callback abandonment coefficient to the identified number of user calls according to the relationship: number of user calls in the call queue multiplied by the callback abandonment coefficient.

16. The predictor device of claim 9, wherein:
when identifying the number of user calls in the call queue the controller is configured to identify a first number of user calls in the call queue for a first time period of a time duration and a second number of user calls in the call queue for a second time period of the time duration;
when predicting the change in the number of user calls in the call queue for the time duration the controller is configured to identify a rate of change in the number of user calls in the call queue between the second number of user calls in the call queue for the second time period of the time duration and the first number of user calls in the call queue for the first time period of the time duration; and
when generating the predicted wait time based upon the predicted change in the number of user calls in the call queue the controller is configured to apply the rate of change in the number of user calls in the call queue to a wait time prediction model to generate the predicted wait time.

17. A contact center, comprising:
a server device comprising a controller having a processor and a memory, the controller comprising a call queue configured to contain a number of user calls; and
a predictor device disposed in electrical communication with the server device and configured to estimate user wait time in the call queue, the predictor device comprising a controller having a processor and a memory, the controller configured to:
identify a number of user calls in the call queue,
predict a change in the number of user calls in the call queue,
generate a predicted wait time based upon the predicted change in the number of user calls in the call queue, and
provide the predicted wait time as the user wait time to the server device.

18. The contact center of claim 17, wherein in response to receiving the predicted wait time as the user wait time, the server device is configured to generate a corresponding wait time action with respect to the user calls within the call queue.

19. The contact center of claim 17, wherein when generating the predicted wait time based upon the predicted change in the number of user calls in the call queue, the predictor device is configured to apply an updated number of user calls in the call queue to a wait time prediction model to generate the predicted wait time.

20. The contact center of claim 19, wherein the predictor device is further configured to select the wait time prediction model from a set of wait time prediction models based upon a score quantifying a performance of each wait time prediction model.
